(19) United States
(12) Patent Application Publication
(10) Pub. No.: US 2017/0164288 A1
(43) Pub. Date: Jun. 8, 2017

(54) METHOD AND APPARATUS FOR COMMUNICATION MANAGEMENT

(71) Applicant: NEC Corporation, Tokyo (JP)

(72) Inventor: Takanori IWAI, Tokyo (JP)

(73) Assignee: NEC Corporation, Tokyo (JP)

(21) Appl. No.: 15/325,970

(22) PCT Filed: May 13, 2015
(86) PCT No.: PCT/JP2015/002420

§ 371 Date: Jan. 12, 2017

(30) Foreign Application Priority Data
Jul. 14, 2014 (JP) 2014-144081

(51) Int. Cl. H04W 52/02; H04W 4/00; H04W 68/00

(52) U.S. Cl. CPC H04W 52/0241; H04W 68/005; H04W 4/005

(57) ABSTRACT

A control plane entity (121 or 122) in a core network (120) receives device information regarding power consumption or remaining charge in a battery of a Machine Type Communication (MTC) device (111) from an MTC service platform (131) that provides an application programming interface (API) for an MTC application server (132) via a network entity (123) in the core network (120). The control plane entity (121 or 122) updates, based on the device information, a paging discontinuous reception cycle separately applied to the MTC device (111).

### TECHNICAL FIELD

The present disclosure relates to a mobile communication network and more particularly to communication management of a Machine Type Communication (MTC) device.

### BACKGROUND ART

The Third Generation Partnership Project (3GPP) has examined the standardization of Machine Type Communication (MTC). The MTC is also referred to as a Machine-to-Machine (M2M) network or a sensor network. The 3GPP defines mobile station (MSs), Mobile Terminals (MTs), or User Equipments (UEs) implemented in machines and sensors for the MTC as “MTC devices”. The MTC devices are typically implemented in various types of equipment including machines (e.g., vending machines, gas meters, electric meters, vehicles, railway vehicles) and sensors (e.g., environmental, agricultural, or traffic sensors). The MTC devices are connected to a Public Land Mobile Network (PLMN) and communicate with an MTC application server (AS). The MTC application server is arranged outside the PLMN (external network), executes an MTC application, and communicates with MTC UE applications implemented in the MTC devices. The MTC application server is typically controlled by an MTC service provider (M2M service provider).

The 3GPP specifies network elements including a Service Capability Server (SCS) and a Machine Type Communication Inter Working Function (MTC-IWF), reference points, and procedures to allow the MTC application server to communicate with the MTC devices (see Non-Patent Literature 1). The reference points are also referred to as “interfaces”.

The SCS is an entity to connect the MTC application server to the 3GPP PLMN and to allow the MTC application server to communicate with a UE (i.e., MTC device) through a PLMN service defined by the 3GPP. Further, the SCS allows the MTC application server to communicate with the MTC-IWF. That is, the SCS provides the MTC application server with an application programming interface (API) to allow the MTC application server to use services or capabilities provided by the 3GPP PLMN. It is assumed that the SCS is controlled by a PLMN operator or an MTC service provider. The framework for intermediation including one or more SCSs is, for example, referred to as an “M2M service platform” or an “MTC service platform”. Further in an Open Mobile Alliance (OMA), this framework, which provides the API for the MTC application server, is referred to as an “exposure layer”.

The MTC-IWF is a control plane entity that belongs to the PLMN. The MTC-IWF has a signaling interface (reference point) with the M2M service platform including the SCS, and also has signaling interfaces (reference points) with nodes in the PLMN (e.g., a Home Subscriber Server (HSS), a Short Message Service-Service Center (SMS-SC), a Serving GPRS Support Node (SGSN), a Mobility Management Entity (MME), a Mobile Switching Center (MSC)). The MTC-IWF serves as a control plane interface to allow the MTC application server or the M2M service platform to cooperate (interwork) with the 3GPP PLMN while hiding the details of the topology of the 3GPP PLMN. The MTC application server or the M2M service platform communicates with each MTC devices via the 3GPP PLMN. The MTC application server or the M2M service platform may communicate with each MTC device on a user plane or using a device trigger.

### CITATION LIST

### Non-Patent Literature

[Non-Patent Literature 1] 3GPP TS 23.682 V11.5.0 (2013-09) “3rd Generation Partnership Project; Technical Specification Group Services and System Aspects; Architecture enhancements to facilitate communications with packet data networks and applications (Release 11)”, September, 2013

### SUMMARY OF INVENTION

### Technical Problem

The inventor has studied various use cases of the MTC application. For example, the MTC device may operate in a plurality of operation modes that are different in power consumption. It can be assumed that the MTC device performs communications more frequently in a small-power-consumption operation mode than in a large-power-consumption operation mode. Further, when the remaining charge in a battery of the MTC device is low, it may be preferable to reduce the activity or operation of the MTC UE 111 to communicate with the PLMN such that the power consumption of the MTC device can be reduced.

It should be noted that MTC-device related information including the operation mode, usage state, the usage environment, remaining charge in its battery and the like can be known by the MTC application server or the M2M service platform (e.g., the SCS) more easily than by the PLMN. This is because the MTC application server or the M2M service platform is able to freely communicate with the MTC device via the PLMN on the user plane (i.e., on an application layer). Alternatively, the MTC application server or the M2M service platform may be able to know the operation mode, the remaining charge in the battery and the like of the MTC device via another communication means implemented in the machine or sensor on which the MTC device is mounted. Further alternatively, the MTC application server or the M2M service platform may be able to know the operation mode, usage state, or usage environment of the MTC device based on warning information regarding weather or oceans announced by government or non-government organizations.

Accordingly, in order to optimize the communication management of the MTC device in the PLMN in accordance with the power consumption or the remaining charge in the battery of the MTC device, it may be preferable to use information regarding the power consumption or the remaining charge in the battery of the MTC device obtained in the MTC application server or the M2M service platform. However, Non-Patent Literature 1 does not teach such a control operation or a control procedure.

Accordingly, one object to be attained by embodiments disclosed herein is to provide a method, an apparatus, and a program that contribute to the communication management of an MTC device in a PLMN using information regarding power consumption of the MTC device or remaining charge in a battery of the MTC device obtained in an MTC application server or an M2M service platform. The other objects or problems and novel features will be made apparent from the following descriptions and the accompanying drawings.

### Solution to Problem

In a first aspect, a method performed by a control plane entity arranged in a core network includes: receiving device information regarding power consumption or remaining charge in a battery of a Machine Type Communication (MTC) device from an MTC service platform via a network entity in the core network, the MTC service platform providing an MTC application server with an application programming interface (API) to allow the MTC application server to use a service served by a mobile communication network including the core network and a radio access network for the MTC application server; and updating, based on the device information, a paging discontinuous reception (DRX) cycle separately applied to the MTC device.

In a second aspect, a control plane entity arranged in a core network includes a memory and a processor that is coupled to the memory and is configured to perform the method according to the aforementioned first aspect.

In a third aspect, a program includes instructions (software codes) that, when loaded into a computer, causes the computer to perform the method according to the aforementioned first aspect.

In a fourth aspect, a method performed by a mobility management entity arranged in a core network includes: receiving device information regarding power consumption or remaining charge in a battery of a Machine Type Communication (MTC) device from an MTC service platform via a network entity in the core network, the MTC service platform providing an MTC application server with an application programming interface (API) to allow the MTC application server to use a service served by a mobile communication network including the core network and a radio access network; and controlling, based on the device information, updating of at least one of (a) a value of a first inactivity timer (e.g., an RRC inactivity timer) used in the radio access network to control a time at which the MTC device in a connected state transitions to an idle state and (b) a value of a second inactivity timer (e.g., a DRX inactivity timer) used in the radio access network to define a time at which the MTC device starts discontinuous reception while being in the connected state.

In a fifth aspect, a method performed by a radio network control entity arranged in a radio access network includes: receiving device information regarding power consumption or remaining charge in a battery of a Machine Type Communication (MTC) device from an MTC service platform via a mobility management entity in the core network, the MTC service platform providing an MTC application server with an application programming interface (API) to allow the MTC application server to use a service served by a mobile communication network including the core network and the radio access network; and determining at least one of a value of a first inactivity timer (e.g., an RRC inactivity timer) and a value of a second inactivity timer (e.g., a DRX inactivity timer) based on the device information.

In a sixth aspect, a mobility management entity arranged in a core network includes a memory and a processor that is coupled to the memory and is configured to perform the method according to the aforementioned fourth aspect.

In a seventh aspect, a radio network control entity arranged in a radio access network includes a memory and a processor that is coupled to the memory and is configured to perform the method according to the aforementioned fifth aspect.

In an eighth aspect, a program includes instructions (software codes) that, when loaded into a computer, causes the computer to perform the method according to the aforementioned fourth aspect.

In a ninth aspect, a program includes instructions (software codes) that, when loaded into a computer, causes the computer to perform the method according to the aforementioned fifth aspect.

In a tenth aspect, a method, performed by a service capability entity that provides an application programming interface (API) for an MTC application server, includes sending a first message indicating device information regarding power consumption or remaining charge in a battery of an MTC device to a control plane entity in the core network. The first message causes an update of at least one of (a) a paging discontinuous reception (DRX) cycle, (b) a value of a first inactivity timer (e.g., an RRC inactivity timer), and (c) a value of a second inactivity timer (e.g., a DRX inactivity timer).

In an eleventh aspect, a service capability entity that provides an application programming interface (API) for an MTC application server includes a memory and a processor that is coupled to the memory and is configured to perform the method according to the aforementioned tenth aspect.

In a twelfth aspect, a program includes instructions (software code) that, when loaded into a computer, causes the computer to execute the method according to the aforementioned tenth aspect.

### Advantageous Effects of Invention

According to the aforementioned aspects, it is possible to provide a method, an apparatus, and a program that contribute to the communication management of an MTC device in a PLMN using information regarding power consumption or remaining charge in a battery of the MTC device obtained in an MTC application server or an M2M service platform.

### BRIEF DESCRIPTION OF DRAWINGS

FIG. 1 is a diagram showing a configuration example of a mobile communication network according to an embodiment of the present invention;

FIG. 2 is a sequence diagram showing a specific example of a procedure for updating a paging DRX cycle according to an embodiment of the present invention;

FIG. 3 is a sequence diagram showing a specific example of a procedure for updating a paging DRX cycle according to an embodiment of the present invention;

FIG. 4 is a sequence diagram showing a specific example of a procedure for updating a paging DRX cycle according to an embodiment of the present invention;

FIG. 5 is a sequence diagram showing a specific example of a procedure for updating an RRC inactivity timer and a DRX inactivity timer according to an embodiment of the present invention;

FIG. 6 is a sequence diagram showing a specific example of a procedure for updating an RRC inactivity timer and a DRX inactivity timer according to an embodiment of the present invention;

FIG. 7 is a block diagram showing a configuration example of an MME according to an embodiment of the present invention;

FIG. 8 is a block diagram showing a configuration example of an HSS/HLR according to an embodiment of the present invention;

FIG. 9 is a block diagram showing a configuration example of an eNodeB according to an embodiment of the present invention; and

FIG. 10 is a block diagram showing a configuration example of an SCS according to an embodiment of the present invention.

### DESCRIPTION OF EMBODIMENTS

Specific embodiments will be described hereinafter in detail with reference to the drawings. Throughout the drawings, the same or corresponding elements are denoted by the same reference symbols, and repetitive explanations will be omitted as appropriate for the sake of clarity.

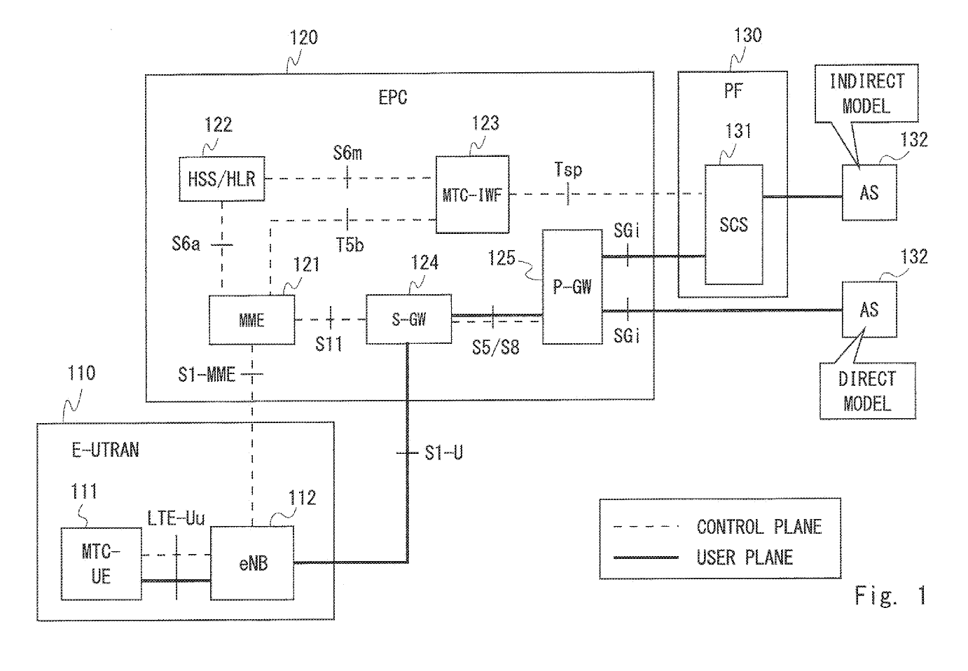

FIG. 1 shows a configuration example of a mobile communication network, i.e., a PLMN, according to an embodiment of the present invention. The mobile communication network provides communication services, such as voice communication or packet data communication or both, for example. In this embodiment, it is assumed that the mobile communication network is an Evolved Packet System (EPS). The EPS may also be referred to as a Long Term Evolution (LTE) system or an LTE-Advanced system. However, this embodiment can also be applied to other radio communication systems such as a Universal Mobile Telecommunications System (UMTS).

The network shown in FIG. 1 includes an E-UTRAN 110, an EPC 120, and an M2M service platform 130. The E-UTRAN 110 includes an MTC device (MTC UE) 111 and an eNodeB 112. The EPC 120 includes an MME 121, an HSS/Home Location Register (HLR) 122, an MTC-IWF 123, a Serving Gateway (S-GW) 124, and a Packet Data Network Gateway (P-GW) 125. The M2M service platform 130 includes an SCS 131. As already stated above, the M2M service platform 130 can also be referred to as an MTC service platform or an exposure layer.

First, entities in the E-UTRAN 110 will be described. The MTC UE 111 executes an MTC UE application and serves as an MTC device. The MTC UE 111, which serves as the MTC device, establishes a signaling connection (i.e., a Non-Access Stratum (NAS) connection) with the MME 121 via the E-UTRAN 110 and communicates with an MTC application server 132 via the S-GW 124 and the P-GW 125 on the user plane.

The MTC UE 111 may be an MTC gateway device. The MTC gateway device has a 3GPP mobile communication function (i.e., a function of a UE) and is connected to a neighboring device (e.g., a sensor, a radio frequency identification (RFID) tag, or a car navigation device) by a personal/local area connection technology. Specific examples of the personal/local area connection technology include IEEE 802.15, ZigBee (registered trademark), Bluetooth (registered trademark), and IEEE 802.11a. The neighboring device connected to the MTC gateway device is typically a device that does not have the 3GPP mobile communication function, but may be a device that has the 3GPP mobile communication function (i.e., an MTC device). In this description, the term “MTC device” and the term “MTC gateway device” are not particularly distinguished from each other. That is, the term “MTC device” used in this description includes the MTC gateway device.

The eNodeB 112 establishes a Radio Resource Control (RRC) connection with the MTC UE 111 and configures a signaling radio bearer (SRB) with the MTC UE 111. Via the SRB, the eNodeB 112 provides RRC signaling to configure and modify a data radio bearer (DRB) and also provides NAS message transfer between the EPC 120 (i.e., the MME 121) and the MTC UE 111, for example. NAS messages are not terminated at the E-UTRAN 110 and are transparently transmitted between the MTC UE 111 and the MME 121. Further, the eNodeB 112 sends and receives user data of the MTC UE 111 via the DRB with the MTC UE 111.

Next, entities in the EPC 120 will be described. The MME 121, the HSS/HLR 122, and the MTC-IWF 123 are control-plane nodes or entities. The MME 121 performs mobility management and bearer management of a plurality of UEs including the MTC UE 111, which have attached to the EPC 120 (i.e., in EMM-REGISTERED state). The mobility management is used to keep track of the current location of each UE and includes maintaining a mobility management context (MM context) regarding each UE. The bearer management includes controlling establishment of an EPS bearer to allow each UE to communicate with an external network (Packet Data Network (PDN)) via the E-UTRAN 110 and the EPC 120 and maintaining an EPS bearer context regarding each UE.

The HSS/HLR 122 manages subscriber information of UEs including the MTC UE 111. Further, the HSS/HLR 122 records information about the MME (e.g., MME Identity) that manages each of the UEs having attached to the EPC 120 (i.e., UEs in EMM-REGISTERED state).

The MTC-IWF 123 is a control plane entity that belongs to the EPC 120. The MTC-IWF 123 communicates with other network entities including the MME 121 and the HSS/HLR 122 via signaling interfaces (reference points). As already stated above, the MTC-IWF 123 serves as a control plane interface or gateway to allow the MTC application server 132 or the M2M service platform 130 to cooperate (interwork) with the 3GPP PLMN while hiding the details of the topology of the 3GPP PLMN.

The MTC-IWF 123 communicates with the SCS 131 via a Tsp reference point. The SCS 131 connects the MTC application server 132 to the PLMN including the E-UTRAN 110 and the EPC 120 and thereby allows the MTC application server 132 to communicate with the MTC UE 111 (that is, the MTC device) via PLMN services defined by the 3GPP. The Tsp reference point may be used, for example, to send a device trigger transmission request (Device Trigger Request (DTR)) from the SCS 131 to the MTC-IWF 123 and to report a device trigger result from the MTC-IWF 123 to the SCS 131.

The MTC-IWF 123 communicates with the HSS/HLR 122 via an S6m reference point. The S6m reference point may be used, for example, to send an inquiry about subscriber information from the MTC-IWF 123 to the HSS/HLR 122 and to send the subscriber information from the HSS/HLR 122 to the MTC-IWF 123.

The MTC-IWF 123 communicates with the MME 121 via a T5b reference point. The T5b reference point may be used, for example, to send a device trigger request from the MTC-IWF 123 to the MME 121 and to report a success or failure of the device trigger from the MME 121 to the MTC-IWF 123.

The S-GW 124 is a user plane packet forwarding node arranged in the EPC 120 and forwards user data packets of the MTC UE 111. The S-GW 124 serves as a gateway to the E-UTRAN 110. The S-GW 124 has a user plane tunneling interface (i.e., an S1-U reference point) to the E-UTRAN 110 and a user plane tunneling interface (i.e., an S5/S8 reference point) to the P-GW 125. The S-GW 124 also has a signaling interface (i.e., an S11 reference point) to the MME 121.

The P-GW 125, as well as the S-GW 124, is a user plane packet forwarding node arranged in the EPC 120 and forwards user data packets of the MTC UE 111. The P-GW 125 serves as a gateway to a PDN outside the 3GPP PLMN and provides connectivity with the PDN for the MTC UE 111. In the example shown in FIG. 1, the PDN includes the SCS 131 and the application server 132.

Next, entities arranged outside the PLMN (the E-UTRAN 110 and the EPC 120) will be described. The M2M service platform 130, which includes the SCS 131, and the MTC application server 132 communicate with the MTC UE 111 via the E-UTRAN 110 and the EPC 120.

The SCS 131 provides the MTC application server 132 with one or more APIs to allow the MTC application server 132 to communicate with the MTC-IWF 123. The SCS 131 is controlled by a PLMN operator or an MTC service provider. The SCS 131 is also referred to as an MTC server, an M2M server, or an API Gateway Function (API-GWF). The SCS 131 may communicate with the MTC UE 111 on the user plane or using a device trigger. The SCS 131 may be a single independent physical entity or may be a functional entity added to another network element (e.g., the MTC-IWF 123 or the MTC application server 132).

The MTC application server 132 executes an MTC application and communicates with the MTC UE application implemented in the MTC UE 111. The MTC application server 132 is also referred to as an M2M application server.

Further, in this embodiment, the mobile communication network (PLMN) including the E-UTRAN 110 and the EPC 120 receives, from the M2M service platform 130, device information indicating behavior or characteristics of the MTC UE 111. Here, the device information regarding the MTC UE 111 explicitly or implicitly indicates power consumption or remaining charge in a battery of the MTC UE 111. The PLMN including the E-UTRAN 110 and the EPC 120 updates, based on the device information on the MTC UE 111 sent from the M2M service platform 130, at least one of (a) a paging discontinuous reception (DRX) cycle, (b) an RRC inactivity timer, and (c) a DRX inactivity timer.

The paging DRX cycle is a time interval at which the MTC UE 111 in an idle state (RRC_IDLE date) checks whether or not a paging occurs. The paging DRX cycle is expressed in terms of the number of radio frames and may be, for example, 32, 64, 128, or 256 radio frames. Longer paging DRX cycle (e.g., 1024 radio frames) may be used for the MTC UE 111. The length of one LTE radio frame is ten milliseconds.

The RRC inactivity timer is used in the E-UTRAN 110 (i.e., the eNodeB 112) to control a time at which the MTC UE 111 in a connected state (RRC_CONNECTED state) transitions to the idle state (RRC_IDLE state). The RRC inactivity timer is also referred to as an IDLE inactivity timer or a UE inactivity timer. The RRC inactivity timer measures a non-communication period of the MTC UE 111 in order to determine a state transition from the RRC_CONNECTED state to the RRC_IDLE state. The MTC UE 111 transitions from the RRC_CONNECTED state to the RRC_IDLE state when the duration of the non-communication period in the RRC_CONNECTED state has reached a predetermined time, or in other words, when the RRC inactivity timer has expired.

The DRX inactivity timer is used in the E-UTRAN 110 (i.e., the eNodeB 112) to define a time at which the MTC UE 111 starts discontinuous reception (DRX) while being in the connected state (RRC_CONNECTED state). The DRX inactivity timer measures a non-communication period in order to transition from an active mode to a DRX mode (a sleep mode or a dormant mode) in the connected state (RRC_CONNECTED state).

It should be noted that the DRX mode in the connected state (RRC_CONNECTED state) is a state in which the RRC connection between the MTC UE 111 and the eNodeB 112 is being maintained and, accordingly, the DRX mode in the connected state (RRC_CONNECTED state) is different from the idle state (RRC_IDLE state). Therefore, the RRC inactivity timer and the DRX inactivity timer are clearly distinguished from each other. The MTC UE 111 re-starts both the RRC inactivity timer and the DRX inactivity timer every time a user data transmission or reception occurs while the MTC UE 111 is in the RRC_CONNECTED state. After transmitting or receiving user data, the MTC UE 111 transitions to the DRX mode in the RRC_CONNECTED state in response to expiration of the DRX inactivity timer and then transitions to the RRC_IDLE state in response to expiration of the RRC inactivity timer. That is, the RRC inactivity timer value is larger than the DRX inactivity timer value. The DRX inactivity timer value is, for example, about 100 milliseconds. On the other hand, the RRC inactivity timer value is, for example, about ten seconds.

Specifically, the M2M service platform 130 (e.g., the SCS 131) may send the device information regarding the MTC UE 111 to the MTC-IWF 123. The MTC-IWF 123 may send this device information to the MME 121 or the HSS/HLR 122 or both. The device information may further be sent to the eNodeB 112 via the MME 121. The device information sent to the MME 121, the HSS/HLR 122, or the eNodeB 112 via the MTC-IWF 123 is used to determine at least one of the paging DRX cycle, RRC inactivity timer value, and DRX inactivity timer value for the MTC UE 111.

When the device information sent from the M2M service platform 130 (e.g., the SCS 131) indicates that the MTC UE 111 is in an operation mode that is low in power consumption or indicates that the remaining charge in the battery of the MTC UE 111 is low, the MME 121 may increase the paging DRX cycle separately applied to the MTC UE 111. In other words, when the operation mode of the MTC UE 111 is a low power consumption mode, the MME 121 may increase the paging DRX cycle for the MTC UE 111 compared to the case in which the operation mode of the MTC UE 111 is a normal mode with higher power consumption. Further or alternatively, the MME 121 may increase the paging DRX cycle for the MTC UE 111 as the remaining charge in the battery of the MTC UE 111 is decreased. When the MTC UE 111 is in the low power consumption mode, it can be estimated that the MTC UE 111 has a large delay tolerance. Further, when the remaining charge in the battery of the MTC UE 111 is low, it can be estimated that communication delay is accepted in order to give priority to reducing the power consumption. By increasing the paging DRX cycle, the power consumption of the MTC UE 111 can be reduced.

Further or alternatively, when the device information sent from the M2M service platform 130 (e.g., the SCS 131) indicates that the MTC UE 111 is in the operation mode that is low in power consumption or that the remaining charge in the battery of MTC UE 111 is low, the eNodeB 112 may decrease the values of the RRC inactivity timer and the DRX inactivity timer which are separately applied to the MTC UE 111. In other words, when the MTC UE 111 is in the low power consumption mode, the eNodeB 112 may decrease both the RRC inactivity timer value and DRX inactivity timer value for the MTC UE 111 compared to the case in which the MTC UE 111 is in the normal mode with larger power consumption. Further or alternatively, the MME 121 may decrease both the RRC inactivity timer value and DRX inactivity timer value for the MTC UE 111 as the remaining charge in the battery of the MTC UE 111 decreases. By decreasing the RRC inactivity timer value or the DRX inactivity timer value, the power consumption of the MTC UE 111 can be reduced.

In the following description, some specific examples of the device information regarding the MTC UE 111 sent from the M2M service platform 130 (e.g., the SCS 131) to the MTC-IWF 123 will be described. As already stated above, the device information explicitly or implicitly indicates the power consumption or the remaining charge in the battery of the MTC UE 111. In one example, the device information may indicate whether the MTC UE 111 is in a first operation mode (e.g., a normal mode) or a second operation mode (e.g., a power saving mode) that is lower in power consumption than the first operation mode. The paging DRX cycle when the MTC UE 111 is in the second operation mode is determined to be longer than that when the MTC UE 111 is in the first operation mode. Further, the values of the RRC inactivity timer and the DRX inactivity timer when the MTC UE 111 is in the second operation mode are determined to be smaller than those when the MTC UE 111 is in the first operation mode.

Further or alternatively, the device information may indicate whether the MTC UE 111 receives power from outside. When the MTC UE 111 receives a stable power supply from outside, it can be estimated that it is preferable for the MTC UE 111 to suppress communication delay rather than to reduce power consumption. On the other hand, when the MTC UE 111 does not receive a stable power supply from outside and operates by its battery, it can be estimated that the MTC UE 111 allows communication delay in order to give priority to reducing its power consumption.

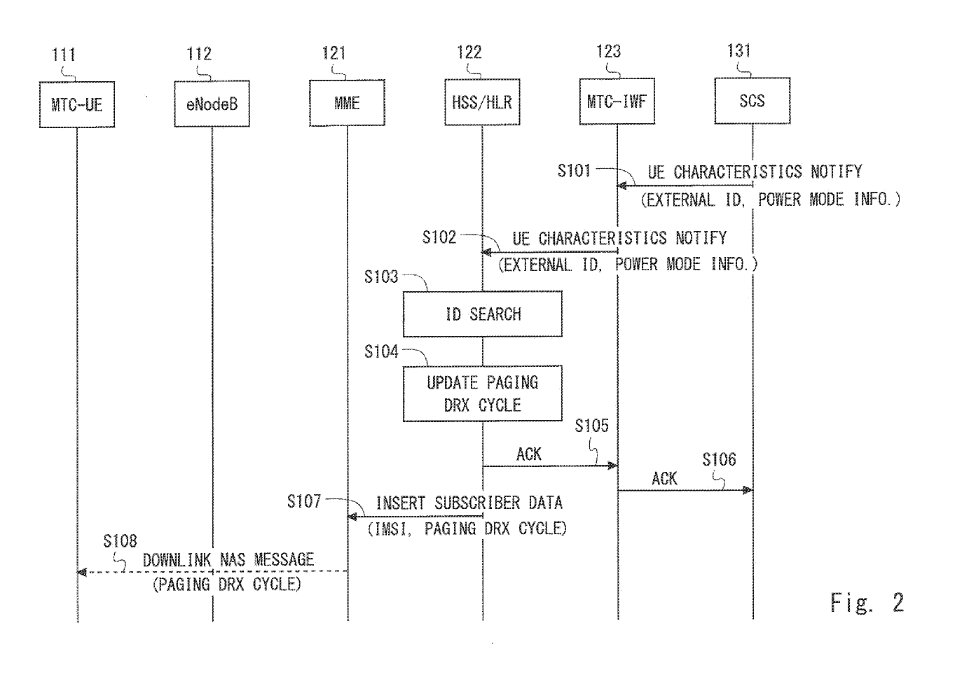

In the following description, a specific example of a procedure for updating values of the paging DRX cycle, the RRC inactivity timer, and the DRX inactivity timer will be described. FIG. 2 shows a specific example of the procedure for updating the paging DRX cycle. In Step S101, the SCS 131 sends a UE CHARACTERISTICS NOTIFY message to the MTC-IWF 123. The SCS 131 may send the UE CHARACTERISTICS NOTIFY message in response to detecting a change in the UE characteristics (specifically, the power consumption, the operation mode, or the remaining charge in the battery) of the MTC UE 111.

The UE CHARACTERISTICS NOTIFY message indicates an external identifier (External ID) of the MTC UE 111 and device information (e.g., power consumption mode (power mode)) on in the MTC UE 111. The external identifier is used to identify the MTC UE 111 in the M2M service platform 130 or the MTC application server 132. The external identifier may be, for example, a Mobile Subscriber Integrated Services Digital Network Number (MSISDN).

In Step S102, the MTC-IWF 123 forwards the UE CHARACTERISTICS NOTIFY message to the HSS/HLR 122. In Step S103, the HSS/HLR 122 receives the UE CHARACTERISTICS NOTIFY message and searches for an internal identifier (Internal ID) of the MTC UE 111 based on the external identifier of the MTC UE 111. The internal identifier may be, for example, an International Mobile Subscriber Identity (IMSI).

In Step S104, the paging DRX cycle value for the MTC UE 111 stored in association with the internal identifier (e.g., the IMSI) of the MTC UE 111 is updated. The value of the paging DRX cycle may be stored in the HSS/HLR 122 as a part of the subscriber information of the MTC UE 111. In Step S105, the HSS/HLR 122 sends a response message (ACK message) to the MTC-IWF 123. In Step S106, the MTC-IWF 123 sends a response message (ACK message) to the SCS 131.

In Step S107, the HSS/HLR 122 notifies the MME 121 of the updating of the paging DRX cycle separately applied to the MTC UE 111. For notifying the MME 121 of the updated value of the paging DRX cycle, the HSS/HLR 122 may use a Diameter message that is sent on the S6a interface between the MME 121 and the HSS/HLR 122. As shown in FIG. 2, an INSERT SUBSCRIBER DATA message may be used. The INSERT SUBSCRIBER DATA message is used by the HSS/HLR 122 to autonomously notify the MME 121 of the subscriber information. The SUBSCRIBER DATA message indicates the internal identifier (the MSISDN) and subscriber information (in this example, the updated value of the paging DRX cycle) of the MTC UE 111.

In Step S108, the MME 121 notifies the MTC UE 111 of the updated paging DRX cycle. The MME 121 uses a NAS message to notify the MTC UE 111 of the updated paging DRX cycle. The MME 121 may send, for example, a TAU ACCEPT message indicating the updated paging DRX cycle to the MTC UE 111 during a TAU procedure. The MTC UE 111 in the idle state (RRC_IDLE state) calculates a Paging Frame (PF) and a Paging Occasion (PO) by using the paging DRX cycle sent from the MME 121 and performs discontinuous reception of a Physical Downlink Control Channel (PDCCH) to receive paging.

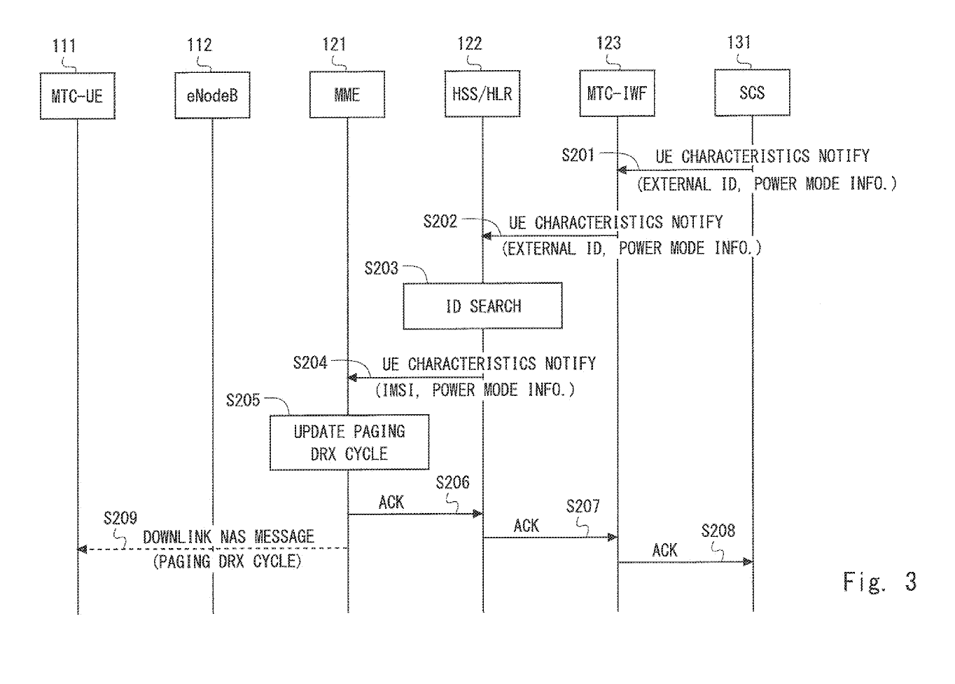

FIG. 3 shows another specific example of the procedure for updating the paging DRX cycle. The processes in Steps S201-S203 are the same as the processes in Steps S101-S103 in FIG. 2.

In Step S204, the HSS/HLR 122 sends a UE CHARACTERISTICS NOTIFY message to the MME 121 that is performing the mobility management of the MTC UE 111. The UE CHARACTERISTICS NOTIFY message sent in Step S204 includes the internal identifier (e.g., the IMSI) to specify the MTC UE 111.

In Step S205, the MME 121 updates the paging DRX cycle separately applied to the MTC UE 111 based on the device information on the MTC UE 111. In Step S206, the MME 121 sends a response message (ACK message) to the HSS/HLR 122. In Step S207, the HSS/HLR 122 sends a response message (ACK message) to the MTC-IWF 123. In Step S208, the MTC-IWF 123 sends a response message (ACK message) to the SCS 131. The process in Step S209 is the same as the process in Step S109 in FIG. 2.

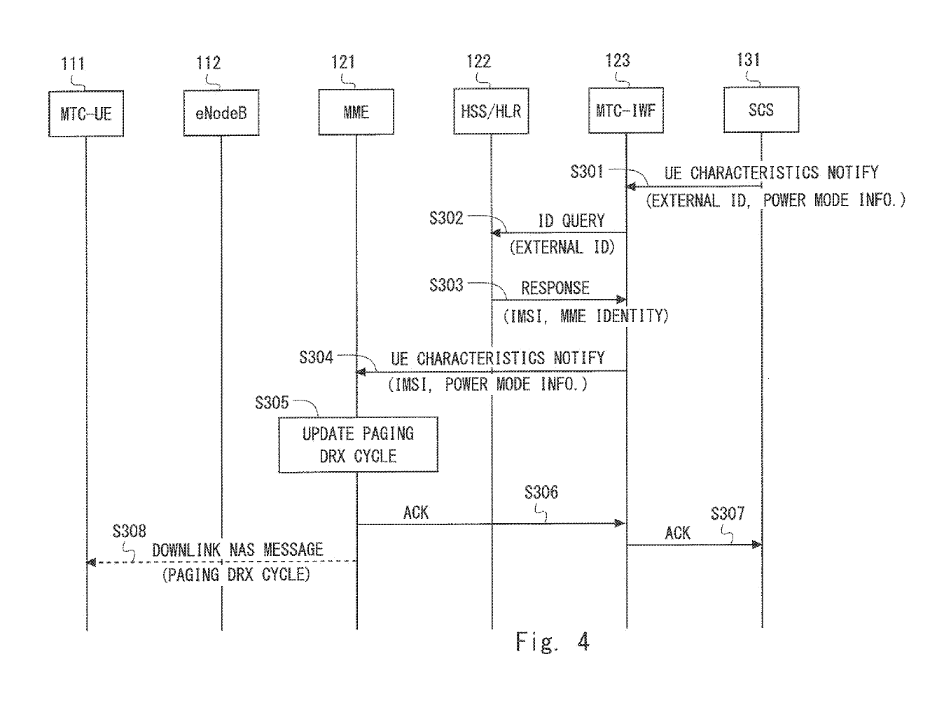

FIG. 4 shows another specific example of the procedure for updating the paging DRX cycle. In the aforementioned example shown in FIG. 3, the MME 121 receives the UE CHARACTERISTICS NOTIFY message indicating the device information (e.g., the power consumption mode (the power mode)) of the MTC UE 111 from the HSS/HLR 122 via the S6a reference point. On the other hand, in the example shown in FIG. 4, the MME 121 receives the UE CHARACTERISTICS NOTIFY message indicating the device information on the MTC UE 111 from the MTC-IWF 123 via the T5b reference point.

The process performed in Step S301 in FIG. 4 is the same as the process performed in Step S201 in FIG. 3. In Step S302, in order to acquire the internal identifier (e.g., the IMSI) of the MTC UE 111, the MTC-IWF 123 sends to the HSS/HLR 122 an inquiry about the internal identifier of the MTC UE 111 corresponding to the external identifier (e.g., the MSISDN) of the MTC UE 111. Specifically, the MTC-IWF 123 may request the HSS/HLR 122 to send the subscriber information corresponding to the external identifier of the MTC UE 111. In Step S303, the HSS/HLR 122 searches for the internal identifier of the MTC UE 111 based on the external identifier of the MTC UE 111. The HSS/HLR 122 then sends to the MTC-IWF 123 a response message indicating the internal identifier (e.g., the IMSI) of the MTC UE 111 and the identifier (MME Identity) of the MME that is performing the mobility management of the MTC UE 111. The MME Identity may be, for example, a Globally Unique MME Identity (GUMMEI), or an IP address of the MME, or both of them. If the MTC-IWF 123 has already known the internal identifier of the MTC UE 111, Steps S302 and S303 may be omitted.

In Step S304, the MTC-IWF 123 sends the UE CHARACTERISTICS NOTIFY message to the MME 121 that is performing the mobility management of the MTC UE 111. The UE CHARACTERISTICS NOTIFY message sent in Step S304 includes the internal identifier (e.g., the IMSI) to specify the MTC UE 111.

The process performed in Step S305 is the same as the process performed in Step S205 in FIG. 3. In Step S306, the MME 121 sends a response message (ACK message) to the MTC-IWF 123. In Step S307, the MTC-IWF 123 sends a response message (ACK message) to the SCS 131. The process performed in Step S308 is the same as the process performed in Step S209 in FIG. 3.

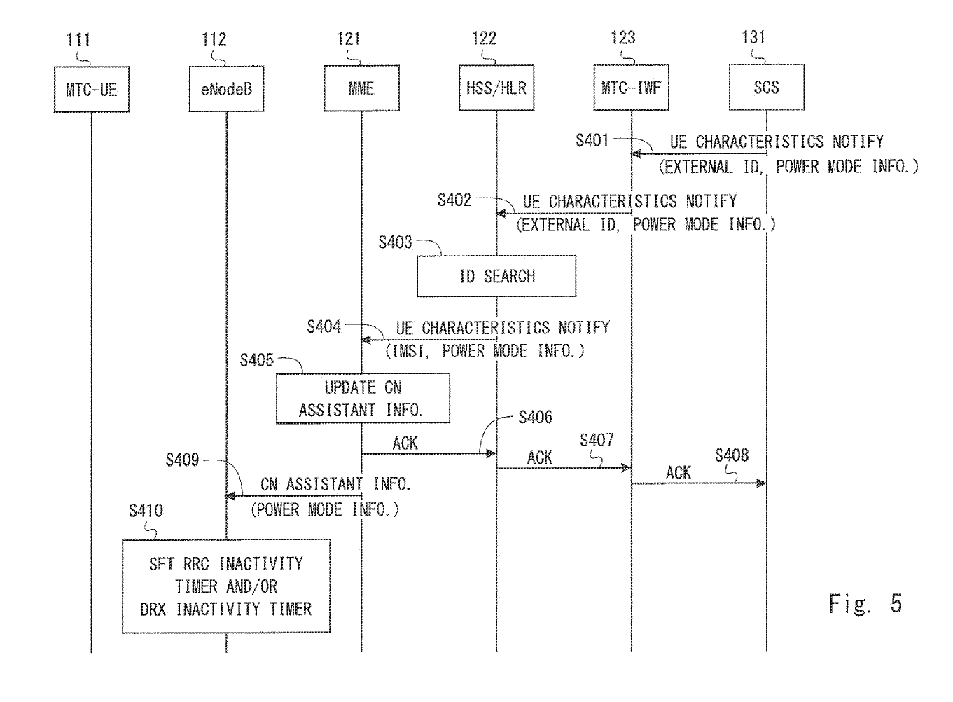

FIG. 5 shows a specific example of the procedure for updating the RRC inactivity timer value and the DRX inactivity timer value. The processes performed in Steps S401-S404 are the same as the processes performed in Steps S201-S204 in FIG. 3.

In Step S405, the MME 121 updates core network (CN) assistant information regarding the MTC UE 111. The MME 121 may hold the device information (e.g., the power consumption mode (the power mode)) of the MTC UE 111 as a part of the MM context of the MTC UE 111. In Step S406, the MME 121 sends a response message (ACK message) to the HSS/HLR 122. In Step S407, the HSS/HLR 122 sends a response message (ACK message) to the MTC-IWF 123. In Step S408, the MTC-IWF 123 sends a response message (ACK message) to the SCS 131.

In Step S409, the MME 121 sends the core network assistant information regarding the MTC UE 111 to the eNodeB 112. In order to send the core network assistant information to the eNodeB 112, an S1AP message sent on the S1-MME interface between the MME 121 and the eNodeB 112 can be used. Specifically, the MME 121 may send the core network assistant information to the eNodeB 112 using an S1AP: INITIAL CONTEXT SETUP REQUEST message during a Service Request procedure initiated by the MTC UE 111.

In Step S410, the eNodeB 112 sets one or both of the RRC inactivity timer and the DRX inactivity timer to be applied to the MTC UE 111, based on the core network assistant information including the device information (e.g., the power consumption mode (the power mode)) of the MTC UE 111 sent from the MME 121. The eNodeB 112 then controls radio communication of the MTC UE 111 using both the RRC inactivity timer and the DRX inactivity timer.

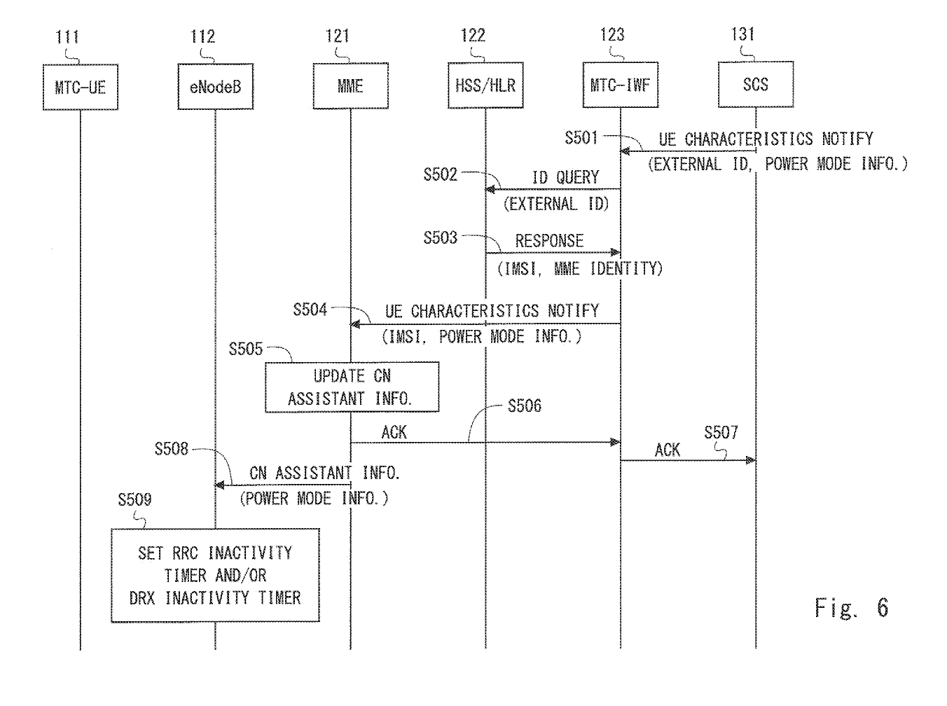

FIG. 6 shows another specific example of the procedure for updating the RRC inactivity timer value and the DRX inactivity timer value. In the example shown in FIG. 6, the MME 121 receives the UE CHARACTERISTICS NOTIFY message indicating the device information on the MTC UE 111 from the MTC-IWF 123 via the T5b reference point. The processes performed in Steps S501-S504 are the same as the processes performed in Steps S301-S304 in FIG. 4. The process performed in Step S505 is the same as the process performed in Step S405 in FIG. 5. The processes performed in Steps S506 and S507 are the same as the processes performed in Steps S306 and S307 in FIG. 4. The processes performed in Steps S508 and S509 are the same as the processes performed in Steps S409 and S410 in FIG. 5.

As will be understood from the aforementioned descriptions, in this embodiment, the MTC-IWF 123 included in the EPC 120 receives the message (e.g., the UE CHARACTERISTICS NOTIFY message) indicating the device information regarding the power consumption or the remaining charge in the battery of the MTC UE 111 from the entity (e.g., the SCS 131) included in the M2M service platform 130. Then the MME 121 included in the EPC 120 determines the paging DRX cycle separately applied to the MTC UE 111 based on the device information on the MTC UE 111 sent from the M2M service platform 130. Further, the eNodeB 112 included in the E-UTRAN 110 determines the RRC inactivity timer value or the DRX inactivity timer value or both, which are separately applied to the MTC UE 111, based on the device information on the MTC UE 111 sent from the M2M service platform 130. Accordingly, the PLMN including the E-UTRAN 110 and the EPC 120 according to this embodiment can use the device information regarding the power consumption or the remaining charge in the battery of the MTC device (i.e., the MTC UE 111), which is obtained in the M2M service platform 130 or the MTC application server 132, to perform the communication management of the MTC device (i.e., the MTC UE 111) in the PLMN.

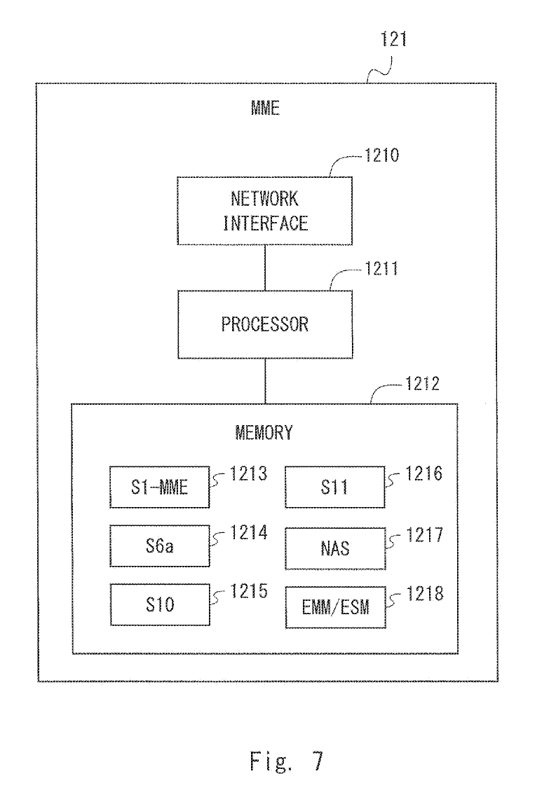

Lastly, configuration examples of the MME 121, the eNodeB 112, and the SCS 131 according to the aforementioned embodiment will be described. FIG. 7 shows a configuration example of the MME 121.

Referring to FIG. 7, the MME 121 includes a network interface 1210, a processor 1211, and a memory 1212. The network interface 1210 is used to communicate with other network nodes (e.g., the eNodeB 112, the HSS/HLR 122, the MTC-IWF 123, and the S-GW 124). The network interface 1210 may include, for example, a network interface card (NIC) conforming to the IEEE 802.3 series.

The processor 1211 loads software (computer program) from the memory 1212 and executes the loaded software, thereby performing communication control (e.g., the mobility management and the bearer management). The processor 1211 may be, for example, a microprocessor, a Micro Processing Unit (MPU), or a Central Processing Unit (CPU). The processor 1211 may include a plurality of processors.

The memory 1212 is composed of a combination of a volatile memory and a nonvolatile memory. The volatile memory is, for example, a Static Random Access Memory (SRAM), a Dynamic RAM (DRAM) or a combination thereof. The nonvolatile memory is, for example, a mask Read Only Memory (MROM), a Programmable ROM (PROM), a flash memory, a hard disc drive, or a combination thereof. The memory 1212 may include a storage physically spaced apart from the processor 1211. In this case, the processor 1211 may access the memory 1212 via the network interface 1210 or another I/O interface (not shown).

In the example shown in FIG. 7, the memory 1212 is used to store software modules including an S1-MME module 1213, an S6a module 1214, an S10 module 1215, an S11 module 1216, a NAS module 1217, and an EPS Mobility Management (EMM)/EPS Session Management (ESM) module 1218. The EMM/ESM module 1218 includes instructions and data to perform the procedure for updating the paging DRX cycle, the RRC inactivity timer, and the DRX inactivity timer based on the device information on the MTC UE 111 sent from the M2M service platform 130, as described in the aforementioned embodiment. The processor 1211 loads the EMM/ESM module 1218 from the memory 1212 and executes the loaded module, thereby performing the operation of the MME 121 regarding the procedure for updating the paging DRX cycle, the RRC inactivity timer, and the DRX inactivity timer described in the aforementioned embodiment.

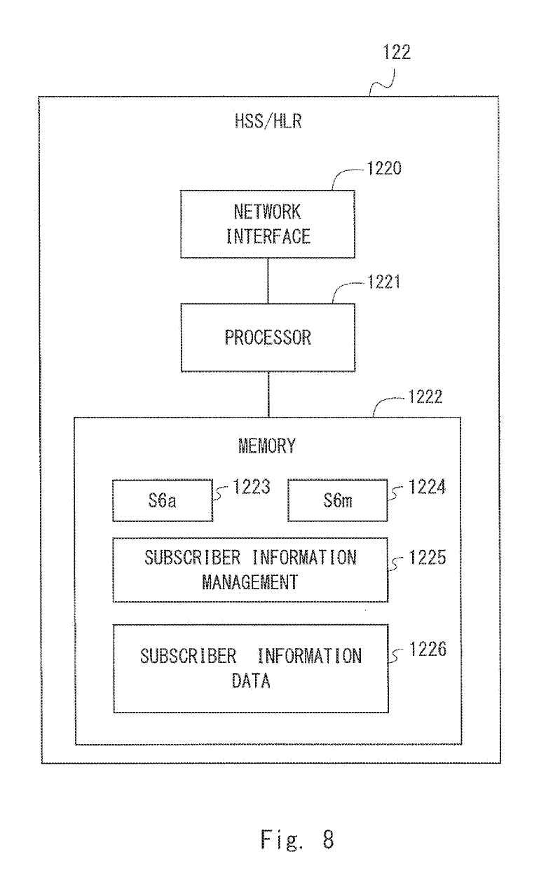

FIG. 8 shows a configuration example of the HSS/HLR 122. Referring to FIG. 8, the HSS/HLR 122 includes a network interface 1220, a processor 1221, and a memory 1222. The network interface 1220 is used to communicate with other network nodes (e.g., the MME 121 and the MTC-IWF 123). The network interface 1220 may include, for example, a network interface card (NIC) conforming to the IEEE 802.3 series.

The processor 1221 loads software (computer program) from the memory 1222 and executes the loaded software, thereby performing communication control including management of the subscriber information. The processor 1221 may be, for example, a microprocessor, an MPU, or a CPU. The processor 1221 may include a plurality of processors.

The memory 1222 is composed of a combination of a volatile memory and a nonvolatile memory. The volatile memory is, for example, an SRAM, a DRAM, or a combination thereof. The nonvolatile memory is, for example, an MROM, a PROM, a flash memory, a hard disc drive, or a combination thereof. The memory 1222 may include a storage that is physically spaced apart from the processor 1221. In this case, the processor 1221 may access the memory 1222 via the network interface 1220 or another I/O interface (not shown).

In the example shown in FIG. 8, the memory 1222 is used to store software modules including an S6a module 1223, an S6m module 1224, and a subscriber information management module 1225, and a subscriber information data 1226. The subscriber information management module 1225 includes instructions and data to perform the procedure for updating the paging DRX cycle, the RRC inactivity timer, and the DRX inactivity timer based on the device information on the MTC UE 111 sent from the M2M service platform 130, as described in the aforementioned embodiment. The processor 1221 loads the subscriber information management module 1225 from the memory 1222 and executes the loaded module, thereby performing the operation of the HSS/HLR 122 regarding the procedure for updating the paging DRX cycle, the RRC inactivity timer, and the DRX inactivity timer described in the aforementioned embodiment.

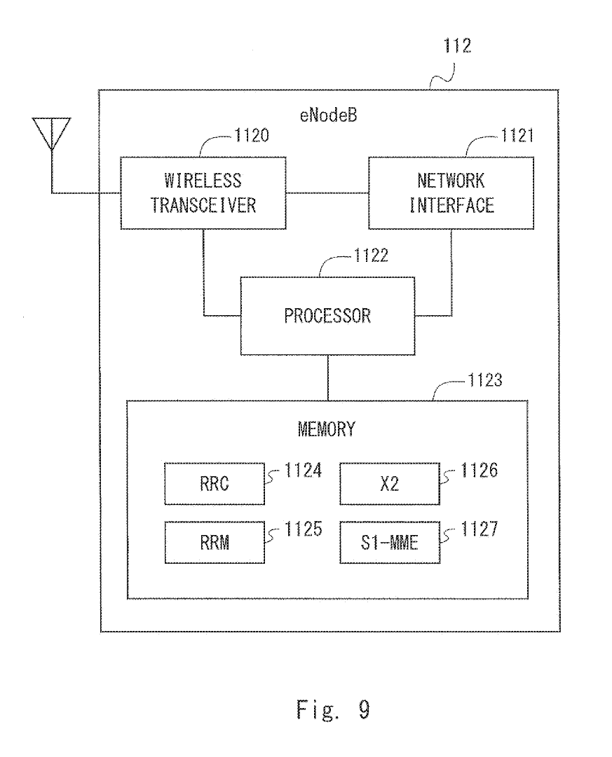

FIG. 9 shows a configuration example of the eNodeB 112. Referring to FIG. 9, the eNodeB 112 includes a wireless transceiver 1120, a network interface 1121, a processor 1122, and a memory 1123. The wireless transceiver 1120 is configured to communicate with a plurality of UEs including the MTC UE 111. The network interface 1121 is used to communicate with another eNodeB in the E-UTRAN 110 and nodes in the EPC 120 (e.g., the MME 121, the S-GW 124).

The processor 1122 loads software (computer program) from the memory 1123 and executes the loaded software, thereby performing the communication control including the RRC and the Radio Resource Management (RRM) and the operations of the eNodeB 112 described in the aforementioned embodiment. The processor 1122 may be, for example, a microprocessor, an MPU, or a CPU. The processor 1122 may include a plurality of processors.

The memory 1123 is composed of a combination of a volatile memory and a nonvolatile memory. The volatile memory is, for example, an SRAM, a DRAM, or a combination thereof. The nonvolatile memory is, for example, an MROM, a PROM, a flash memory, a hard disc drive, or a combination thereof. The memory 1123 may include a storage spaced apart from the processor 1122. In this case, the processor 1122 may access the memory 1123 via the network interface 1121 or another I/O interface (not shown).

In the example shown in FIG. 9, the memory 1123 is used to store software modules including an RRC module 1124, an RRM module 1125, an X2 module 1126, and an S1-MME module 1127. The processor 1122 loads the RRC module 1124 from the memory 1123 and executes the loaded module, thereby performing the operation of the eNodeB 112 regarding the procedure for updating the RRC inactivity timer value and the DRX inactivity timer value, as described in the aforementioned embodiment.

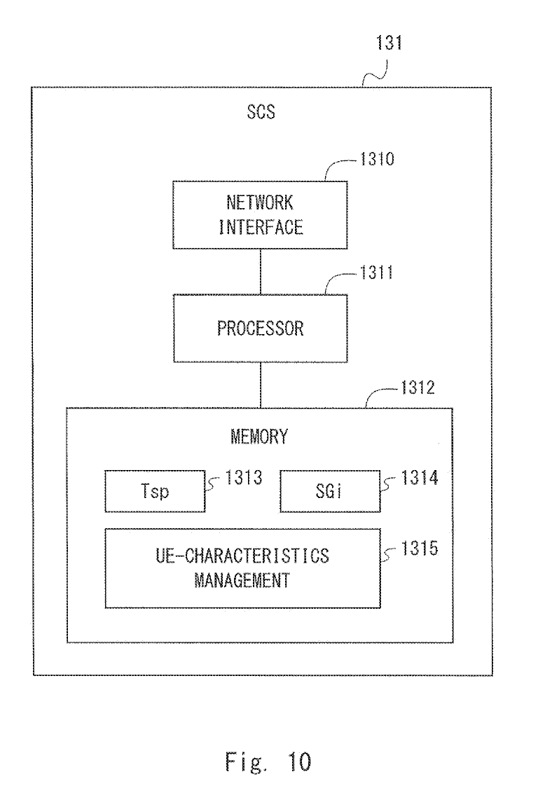

FIG. 10 shows a configuration example of the SCS 131. Referring to FIG. 10, the SCS 131 includes a network interface 1310, a processor 1311, and a memory 1312. The network interface 1310 is used to communicate with other network nodes (e.g., the MTC-IWF 123 and the MTC application server 132). The network interface 1310 may include, for example, a network interface card (NIC) conforming to the IEEE 802.3 series.

The processor 1311 loads software (computer program) from the memory 1312 and executes the loaded software, thereby performing communication control for the MTC device (e.g., device trigger and acquisition of the communication characteristics of the MTC device). The processor 1311 may be, for example, a microprocessor, an MPU, or a CPU. The processor 1311 may include a plurality of processors.

The memory 1312 is composed of a combination of a volatile memory and a nonvolatile memory. The volatile memory is, for example, an SRAM, a DRAM, or a combination thereof. The nonvolatile memory is, for example, an MROM, a PROM, a flash memory, a hard disc drive, or a combination thereof. The memory 1312 may include a storage physically spaced apart from the processor 1311. In this case, the processor 1311 may access the memory 1312 via the network interface 1310 or another I/O interface (not shown).

In the example shown in FIG. 10, the memory 1312 is used to store software modules including a Tsp module 1313, an SGi module 1314, and a UE characteristics management module 1315. The UE characteristics management module 1315 includes instructions and data to perform the procedure for notifying the EPC 120 (i.e., the MTC-IWF 123) of the device information on the MTC UE 111 obtained by the M2M service platform 130 or the MTC application server 132, as described in the aforementioned embodiment. The processor 1311 loads the UE characteristics management module 1315 from the memory 1312 and executes the loaded module, thereby performing the operation of the SCS 131 regarding the procedure for updating the paging DRX cycle, the RRC inactivity timer, and the DRX inactivity timer described in the aforementioned embodiment.

As described with reference to FIGS. 7-10, the processors included in the MME 121, the HSS/HLR 122, the eNodeB 112, and the SCS 131 according to the aforementioned embodiment each execute one or more programs including instructions that cause a computer to perform the algorithm described with reference to the sequence diagrams or the like.

These programs can be stored and provided to a computer using any type of non-transitory computer readable media. Non-transitory computer readable media include any type of tangible storage media. Examples of non-transitory computer readable media include magnetic storage media (such as flexible disks, magnetic tapes, hard disk drives, etc.), optical magnetic storage media (e.g., magneto-optical disks), Compact Disc Read Only Memory (CD-ROM), CD-R, CD-R/W, and semiconductor memories (such as mask ROM, Programmable ROM (PROM), Erasable PROM (EPROM), flash ROM, Random Access Memory (RAM), etc.). These programs may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

### OTHER EMBODIMENTS

The architecture shown in FIG. 1 is merely one example of the architecture for the MTC in the 3GPP. For example, the functions and the entities arranged in the M2M service platform 130 (the MTC service platform, the exposure layer) and the names thereof may be changed in the future releases or versions. The SCS 131 described in the aforementioned embodiment may be referred to as, for example, an API Gateway Function (API-GWF). Alternatively, the functions of the SCS 131 may be divided into an SCS and an API-GWF. The technical ideas described in the aforementioned embodiment can also be applied to these modified architectures for the MTC.

The descriptions have been given in the aforementioned embodiment mainly using the specific examples regarding the EPS. However, the aforementioned embodiment may be applied to other mobile communication systems (e.g., a Universal Mobile Telecommunications System (UMTS), a 3GPP2 CDMA2000 system (1×RTT, High Rate Packet Data (HRPD)), a Global System for Mobile communications (GSM (registered trademark))/General packet radio service (GPRS) system, and a mobile WiMAX system).

Further, the above-described embodiments are merely examples regarding applications of technical ideas obtained by the inventor. Needless to say, these technical ideas are not limited to the above-described embodiments and may be changed in various ways.

This application is based upon and claims the benefit of priority from Japanese Patent Application No. 2014-144081, filed on Jul. 14, 2014, the disclosure of which is incorporated herein in its entirety by reference.

### REFERENCE SIGNS LIST

110 Evolved Universal Terrestrial Radio Access Network (E-UTRAN)
111 User Equipment (UE)
112 eNodeB
120 Evolved Packet Core (EPC)
121 Mobility Management Entity (MME)
122 Home Subscriber Server (HSS)
123 Machine Type Communication Inter Working Function (MTC-IWF)
124 Serving Gateway (S-GW)
125 Packet Data Network Gateway (P-GW)
130 Machine-to-Machine (M2M) service platform
131 Service Capability Server (SCS)
132 MTC Application Server (AS)

1. A method performed by a control plane entity arranged in a core network, the method comprising:
receiving device information regarding power consumption or remaining charge in a battery of a Machine Type Communication (MTC) device from an MTC service platform via a network entity in the core network, the MTC service platform providing an MTC application server with an application programming interface (API) to allow the MTC application server to use a service served by a mobile communication network including the core network and a radio access network; and
updating, based on the device information, a paging discontinuous reception (DRX) cycle separately applied to the MTC device.

2. The method according to claim 1, wherein
the control plane entity is a subscriber server configured to manage subscriber information on the MTC device, and
the updating comprises updating a value indicating the paging DRX cycle managed by the sub scriber server.

3. The method according to claim 1, wherein
the control plane entity is a mobility management entity configured to perform mobility management of the MTC device, and
the updating comprises updating a value indicating the paging DRX cycle managed by the mobility management entity.

4. The method according to claim 1, wherein the device information indicates whether the MTC device is in a first operation mode or a second operation mode that is lower in power consumption than the first operation mode.

5. The method according to claim 4, wherein the paging DRX cycle when the MTC device is in the second operation mode is determined to be longer than the paging DRX cycle when the MTC device is in the first operation mode.

6. The method according to claim 1, wherein the device information indicates the remaining charge in the battery of the MTC device.

7. The method according to claim 6, wherein the paging DRX cycle is determined to be longer as the remaining charge in the battery of the MTC device decreases.

8. A control plane entity arranged in a core network, the control plane entity comprising:
a memory that stores instructions; and
a processor coupled to the memory and configured to execute the instructions to:
receive device information regarding power consumption or remaining charge in a battery of a Machine Type Communication (MTC) device from an MTC service platform via a network entity in the core network, the MTC service platform providing an MTC application server with an application programming interface (API) to allow the MTC application server to use a service served by a mobile communication network including the core network and a radio access network; and
update, based on the device information, a paging discontinuous reception (DRX) cycle separately applied to the MTC device.

9. (canceled)

10. (canceled)

11. (canceled)

12. (canceled)

13. (canceled)

14. (canceled)

15. (canceled)

16. (canceled)

17. A mobility management entity arranged in a core network, the mobility management entity comprising:
a memory that stores instructions; and
a processor coupled to the memory and configured to execute the instructions to:
receive device information regarding power consumption or remaining charge in a battery of a Machine Type Communication (MTC) device from an MTC service platform via a network entity in the core network, the MTC service platform providing an MTC application server with an application programming interface (API) to allow the MTC application server to use a service served by a mobile communication network including the core network and a radio access network; and
control, based on the device information, updating of at least one of (a) a value of a first inactivity timer used in the radio access network to control a time at which the MTC device in a connected state transitions to an idle state and (b) a value of a second inactivity timer used in the radio access network to define a time at which the MTC device starts discontinuous reception while being in the connected state.

18. (canceled)

19. (canceled)

20. (canceled)

21. (canceled)

22. (canceled)

23. (canceled)

24. The control plane entity according to claim 8, wherein
the control plane entity is a subscriber server configured to manage subscriber information on the MTC device, and
the instructions cause the processor to update a value indicating the paging DRX cycle managed by the subscriber server.

25. The control plane entity according to claim 8, wherein
the control plane entity is a mobility management entity configured to perform mobility management of the MTC device, and
the instructions cause the processor to update a value indicating the paging DRX cycle managed by the mobility management entity.

26. The control plane entity according to claim 8, wherein the device information indicates whether the MTC device is in a first operation mode or a second operation mode that is lower in power consumption than the first operation mode.

27. The control plane entity according to claim 26, wherein the paging DRX cycle when the MTC device is in the second operation mode is determined to be longer than the paging DRX cycle when the MTC device is in the first operation mode.

28. The control plane entity according to claim 8, wherein the device information indicates the remaining charge in the battery of the MTC device.

29. The control plane entity according to claim 28, wherein the paging DRX cycle is determined to be longer as the remaining charge in the battery of the MTC device decreases.

30. The mobility management entity according to claim 17, wherein the instructions cause the processor to notify a radio network control entity in the radio access network of the device information in order to update at least one of the first and second inactivity timers.
